(19) United States
(12) Patent Application Publication
(10) Pub. No.: US 2014/0268009 A1
(43) Pub. Date: Sep. 18, 2014

(54) EYE-LENS DEVICE

(71) Applicant: LIN YUAN CHEN, TAINAN CITY (TW)

(72) Inventor: LIN YUAN CHEN, TAINAN CITY (TW)

(21) Appl. No.: 13/838,334

(22) Filed: Mar. 15, 2013

(51) Int. Cl. G02C 5/14

(52) U.S. Cl. CPC G02C 5/14
USPC 351/111

(57) ABSTRACT

An eye-lens device includes a frame, two temples, at least one lens and an airflow-guiding element. The temples are respectively disposed to two ends of the frame. The lens is fixed to the frame. The airflow-guiding element is fixed to the frame, and an airflow-guiding channel is formed between the frame and the airflow-guiding element.

### BACKGROUND OF THE INVENTION

1. Field of the Invention

The invention relates to an eye-lens device.

2. Description of the Prior Art

The eyeglasses, such as sunglasses, safety eyeglasses, nearsighted eyeglasses or farsighted spectacles, have become an indispensible appliance, helping people's living a lot. The technology related to the eyeglasses has been developed for a long time, but there are still some inconveniences for the use. For example, the eyeglasses will mist over when the opposite surfaces of the lens undergo different temperatures, and then the user can not see clearly for a while. Accordingly, the user may experience a dangerous situation or an inconvenient use.

Therefore, it is an important subject to provide an eye-lens device that can make the mist dissipate easily so as to enhance the usability and product competitiveness.

### SUMMARY OF THE INVENTION

In view of the foregoing subject, an objective of the invention is to provide an eye-lens device that can make the mist dissipate easily so as to enhance the usability and product competitiveness.

To achieve the above objective, an eye-lens device according to the invention comprises a frame, two temples, at least one lens and an airflow-guiding element. The temples are respectively disposed to two ends of the frame. The lens is fixed to the frame. The airflow-guiding element is fixed to the frame. An airflow-guiding channel is formed between the frame and the airflow-guiding element.

In one embodiment, the lens is embedded to a slot of the frame.

In one embodiment, the airflow-guiding channel is formed by the frame and the airflow-guiding element, or only by the airflow-guiding element.

In one embodiment, the airflow-guiding channel is extended from one end of the frame to the other end of the frame.

In one embodiment, the airflow-guiding channel has a plurality of directions, and two of them are perpendicular to each other.

In one embodiment, an airflow flows from the middle of the frame to one end of the frame through the airflow-guiding channel.

In one embodiment, the frame has an airflow-guiding hole, and an airflow flows to the airflow-guiding channel through the airflow-guiding hole.

In one embodiment, the airflow-guiding element and the frame are connected by engaging or forming integrally.

In one embodiment, the airflow-guiding element is disposed on a top side of the frame.

In one embodiment, the eye-lens device further comprises a blocking element, which is disposed to the frame or the airflow-guiding element and contacts a user's face when the user wears the eye-lens device.

As mentioned above, because the eye-lens device according to the invention has an airflow-guiding element and an airflow-guiding channel is formed between the frame and the airflow-guiding element, an airflow will flow to between the lens and the user's face through the airflow-guiding channel when the airflow comes in through the eye-lens device, taking the heat of the user's face. Thereby, the temperatures of the opposite surfaces of the lens will be made the same quickly, and thus the moist will not occur on the lens so that the usability and product competitiveness can be increased a lot. Besides, when the user moves with a speed, the airflow-guiding channel of the eye-lens device of this invention can cause the user to feel cool.

### BRIEF DESCRIPTION OF THE DRAWINGS

FIG. 1 is a schematic diagram of an eye-lens device according to a preferred embodiment of the invention;

FIGS. 2 and 3 are schematic exploded diagrams from different viewpoints of the eye-lens device in FIG. 1;

FIGS. 4 and 5 are schematic diagrams showing the partial section of the eye-lens device according to the embodiment of the invention from different viewpoints; and

FIG. 6 is a schematic diagram of another eye-lens device according to the embodiment of the invention.

### DETAILED DESCRIPTION OF THE INVENTION

FIG. 1 is a schematic diagram of an eye-lens device 1 according to a preferred embodiment of the invention, and FIGS. 2 and 3 are schematic exploded diagrams from different viewpoints of the eye-lens device 1 in FIG. 1. As shown in FIGS. 1 to 3, the eye-lens device 1 includes a frame 11, two temples 12, at least one lens 13 and an airflow-guiding element 14. In the invention, the eye-lens device 1 is not limited in type, which can be sunglasses, safety eyeglasses, nearsighted eyeglasses, farsighted spectacles, snow eyeglasses, or the like.

The frame 11 of this embodiment is not limited in shape or curvature, which can be modified according to the practical requirements. The frame 11 is also not limited in material, which can be made by, for example, metal, alloy or plastic material. In this embodiment, the frame 11 is bar-shaped, and has a lengthwise slot 111 corresponding to the single lens 13 for holding the lens 13, but however the invention is not limited thereto. Besides, the frame 11 can have an airflow-guiding hole 112 through which the incoming airflow can pass, for the purpose of guiding airflow. In this embodiment, the airflow-guiding hole 112 is disposed in the midst of the frame 11 for example, and the number of the airflow-guiding hole 112 is just one, but this invention is not limited thereto. In other embodiments, the frame 11 can be without the airflow-guiding hole 112, and the incoming airflow is directly guided by the airflow-guiding element 14 instead of the airflow-guiding hole.

Two temples 12 are respectively disposed at two ends of the frame 11 and can be laid on the ears of the user. In the embodiment, the temples 12 are not limited in shape and material. For example, the temples 12 can each have a hook or no hook, and can be made by metal, alloy, or plastic material. Herein, the temples 12 are disposed pivotally to the frame 11 for example. In other embodiments, the temples 12 can be disposed to the frame 11 by, for example, locking, engaging, or forming integrally.

The lens 13 is fixed to the frame 11. The lens 13 is not limited in type, which can be a nearsighted lens, a farsighted lens, a multi-focus lens, or a filter lens. The number of the lens 13 can be one or two, and there is only one lens 13 in this embodiment. The lens 13 can cover the range of one or two eyes of the user, and here as an example, covers the range of two eyes of the user. In this embodiment, the lens 13 is embedded in a lens slot 111 of the frame 1. Otherwise, the lens 13 can be disposed to the frame 11 by, for example, locking, engaging, or forming integrally.

The airflow-guiding element 14 is fixed to the frame 11, and an airflow-guiding channel 141 is formed between the frame 11 and the airflow-guiding element 14. The airflow-guiding channel 141 can be formed by both of the frame 11 and airflow-guiding element 14, or only by the airflow-guiding element 14, and here for example, it is formed by both of the frame 11 and airflow-guiding element 14. The airflow-guiding channel 141 can be formed by an indentation and a sidewall or by two indentations. The said indentation and sidewall or the said indentations can be disposed to the frame 11 and the airflow-guiding element 14, respectively, or can be only disposed to the airflow-guiding element 14, to form the airflow-guiding channel. In FIGS. 3 and 4, a front side of the airflow-guiding element 14 has an indentation 142, and a rear side of the frame 11 has an indentation 113, too. The two indentations 142 and 113 are disposed adjacent to each other to form the airflow-guiding element 141.

The airflow-guiding channel 141 is not limited in shape, which can be lengthwise or has some branches, which are along different directions (such as perpendicular to each other). In this embodiment, the airflow-guiding channel 141 is extended from one end of the frame 11 to the other end of the frame 11. Besides, as shown in FIG. 2, by the special design of the indentation 142 of the airflow-guiding element 14 (including the main indentation 1421 and the secondary indentation 1422), the airflow-guiding channel 141 can have a plurality of guiding directions, and two of them are perpendicular to each other, which can be seen clearly in FIGS. 4 and 5. FIGS. 4 and 5 are schematic diagrams showing the partial section of the eye-lens device 1 from different viewpoints. As shown in FIGS. 4 and 5, after the airflow comes in through the airflow-guiding hole 112, it flows into the portion of the airflow-guiding channel 141 parallel with the lengthwise direction of the frame 11 (or the airflow-guiding element 14), and then is guided to the portion of the airflow-guiding channel 141 perpendicular to the lengthwise direction of the frame 11 (or the airflow-guiding element 14) to leave the eye-lens device 1. Thereby, the airflow can flow downwards to the face of the user to take the heat of the face so that the temperatures of the opposite surfaces of the lens 13 can be made the same and thus the moist will not occur on the lens 13.

Accordingly, through the airflow-guiding channel, an airflow will flow from the middle of the frame 11 to one end of the frame and then flow downwards to leave the eye-lens device 1. The flowing direction of the above-mentioned airflow is just for example. The airflow can be guided to other directions, and for example, it can be guided through the airflow-guiding channel to leave the lens directly from one end of the frame.

The airflow-guiding element 14 and the frame 11 can be connected to each other by, for example, engaging or forming integrally, and here they are connected by engaging for example. As shown in FIGS. 2 and 3, the frame 11 has a plurality of connection holes 114, and the airflow-guiding element 14 has a plurality of connection protrusions 143 which can connect to the connection holes 114. The above connection means is just for example, and in other embodiments the frame 11 can have the connection protrusion and the airflow-guiding element 14 can have the connection hole for the mutual connection, for example.

Besides, in this embodiment, the airflow-guiding element 14 is disposed on a top side of the frame 11 so that the airflow can flow downwards from the frame 11 and then take the heat of the user's face. In other embodiments, the frame 11 has at least one frame portion for holding the lens, and the airflow-guiding element 14 can be disposed on a bottom side of the frame portion of the frame 11 so that an airflow can flow upwards from the frame 11 to take the heat of the user's face.

As shown in FIG. 6, the eye-lens device 1 can further include a blocking element 15, which can be disposed to the frame 11 or the airflow-guiding element 14. Herein, the blocking element 15 is disposed to the airflow-guiding element 14 for example. When a user wears the eye-lens device 1, the blocking element 15 can contact the user's face. The blocking element 15 can block the sweat (or other objects, such as rain) from flowing to the eyes. The blocking element 15 can be made by sponge, rubber or plastic material for example. Herein, the blocking element 15 is not limited in material.

In summary, because the eye-lens device according to the invention has an airflow-guiding element and an airflow-guiding channel is formed between the frame and the airflow-guiding element, an airflow will flow to between the lens and the user's face through the airflow-guiding channel when the airflow comes in through the eye-lens device, taking the heat of the user's face. Thereby, the temperatures of the opposite surfaces of the lens will be made the same quickly, and thus the moist will not occur on the lens so that the usability and product competitiveness can be increased a lot. Besides, when the user moves with a speed, the airflow-guiding channel of the eye-lens device of this invention can cause the user to feel cool.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An eye-lens device, comprising:
a frame;
two temples respectively disposed to two ends of the frame;
at least one lens fixed to the frame; and
an airflow-guiding element fixed to the frame, wherein an airflow-guiding channel is formed between the frame and the airflow-guiding element.

2. The eye-lens device as recited in claim 1, wherein the lens is embedded to a slot of the frame.

3. The eye-lens device as recited in claim 1, wherein the airflow-guiding channel is formed by the frame and the airflow-guiding element, or only by the airflow-guiding element.

4. The eye-lens device as recited in claim 1, wherein the airflow-guiding channel is extended from one end of the frame to the other end of the frame.

5. The eye-lens device as recited in claim 1, wherein the airflow-guiding channel has a plurality of directions, and two of them are perpendicular to each other.

6. The eye-lens device as recited in claim 1, wherein an airflow flows from the middle of the frame to one end of the frame through the airflow-guiding channel.

7. The eye-lens device as recited in claim 1, wherein the frame has an airflow-guiding hole, and an airflow flows to the airflow-guiding channel through the airflow-guiding hole.

8. The eye-lens device as recited in claim 1, wherein the airflow-guiding element and the frame are connected by engaging or forming integrally.

9. The eye-lens device as recited in claim 1, wherein the airflow-guiding element is disposed on a top side of the frame.

10. The eye-lens device as recited in claim 1, further comprising:
a blocking element disposed to the frame or the airflow-guiding element and contacting a user's face when the user wears the eye-lens device.
